(19) United States
(12) Patent Application Publication
(10) Pub. No.: US 2013/0041786 A1
(43) Pub. Date: Feb. 14, 2013

(54) Effective Indentification of a Product in a Proprietary Supplier Catalog

(71) Applicant: Alexander Omeed Adegan, Los Angeles, CA (US)

(72) Inventor: Alexander Omeed Adegan, Los Angeles, CA (US)

(21) Appl. No.: 13/655,440

(22) Filed: Oct. 18, 2012

Related U.S. Application Data
(63) Continuation-in-part of application No. 11/007,589, filed on Dec. 9, 2004.
(60) Provisional application No. 61/548,561, filed on Oct. 18, 2011.

(51) Int. Cl. G06Q 10/08

(52) U.S. Cl. 705/29

(57) ABSTRACT

Devices, systems, and methods are disclosed which use known characteristics of a part to identify that part's equivalent from a supplier with a proprietary part catalog which contains characteristics defined using different structure, standards and nomenclature. The system tries to identify the correct part number or equivalent to a given part, but the supplier may have a different part numbering system than used by the individuals performing the search. The system then utilizes at least one part characteristic and/or a vehicle identifier and uses them to search the proprietary supplier catalog to retrieve a part record with substantially similar part characteristics.

This application claims priority to U.S. Provisional Patent Application Ser. No. 61/548,561, filed on Oct. 18, 2011; and is a continuation-in-part of U.S. patent application Ser. No. 11/007,589, filed on Dec. 9, 2004, which claims priority to U.S. Provisional Patent Application Ser. No. 60/527,762, filed on Dec. 9, 2003; the contents of which are incorporated by reference herein in their entirety into this disclosure.

### BACKGROUND OF THE SUBJECT DISCLOSURE

1. Field of the Subject Disclosure

The present subject disclosure relates to parts. More specifically, the present subject disclosure relates to identifying parts.

2. Background of the Subject Disclosure

There are generally three types of auto parts in the automotive industry. OEM parts (brand new parts utilized by manufacturers in creating a vehicle), aftermarket (or AM) parts (alternative parts supplied by non-manufacturers as a cheaper substitute for OEM parts), and used parts (also known as salvage parts, recycled parts, or LKQ, Like Kind & Quality parts). Used parts are often OEM parts that have been previously used or are second hand. The part numbering systems for each of these part types are entirely different, even between different suppliers of the same part type. In other words, an alternator for a given vehicle from an OEM parts supplier may have a part number ABX1023403. This same alternator from a used-parts supplier may have a used-part number XYZ222314. Therefore, there is a need for automatic identification of these different part numbering systems to systematically identify, search, and procure parts from one supplier with information of a part numbering system from another supplier.

OEM part manufacturers and automakers have for years employed proprietary part numbering systems for their internal purposes and for proper identification of their parts. Further, there are a number of existing methods for locating and utilizing parts. These methods invariably involve manual location of these parts individuals often employed by the catalog creators and therefore familiar with their structure, standards and nomenclature.

Conventionally, identification of parts involves employing several people to manually determine which parts correspond to which parts from a supplier, and to call various suppliers in order to obtain current part pricing and location information prior to procuring those parts. These processes are highly manual and require human operators to have full understand ding of parts that are sent via fax, e-mail, read over the phone, or submitted electronically. The content of these purchase requests are then examined to validate the accuracy of the parts being purchased and to possibly replace any of the parts within a given purchase order with other part types or parts from other suppliers.

### SUMMARY OF THE SUBJECT DISCLOSURE

The present subject disclosure solves the problems identified above by using known characteristics of a part to identify that part's equivalent from a supplier with a proprietary part catalog which contains characteristics defined using different structure, standards and nomenclature.

In one example embodiment, the present subject disclosure is method for effectively identifying a part based on a plurality of part characteristics that are defined in a non-obvious form with respect to a proprietary supplier catalog where those characteristics are defined using different structure, standard, and nomenclature. The method includes identifying a supplier part number in the proprietary supplier catalog using the plurality of part characteristics.

In another example embodiment, the present subject disclosure is a system for effectively identifying a part based on a plurality of part characteristics that are defined in a non-obvious form with respect to a proprietary supplier catalog where those characteristics are defined using different structure, standard, and nomenclature. The system includes a server including a processor; and a computer-readable medium in communication with the server, the computer-readable medium having a plurality of instructions stored thereon which, when executed by the processor, cause the processor to perform operations including identifying a supplier part number in the proprietary supplier catalog using the plurality of part characteristics.

In yet another example embodiment, the present subject disclosure is a non-transitory computer-readable medium having a plurality of instructions stored thereon which, when executed by a processor, cause the processor to perform a method for effectively identifying a part based on a plurality of part characteristics that are defined in a non-obvious form with respect to a proprietary supplier catalog where those characteristics are defined using different structure, standard, and nomenclature. The method includes identifying a supplier part number in the proprietary supplier catalog using the plurality of part characteristics.

### BRIEF DESCRIPTION OF THE DRAWINGS

FIG. 1 shows a system for identifying automotive parts, according to an example embodiment of the present subject disclosure.

FIG. 2 shows a supplier part catalog database, according to an example embodiment of the present subject disclosure.

FIG. 3 shows an artificial intelligence database, according to an example embodiment of the present subject disclosure.

FIG. 4 shows an identification request, according to an example embodiment of the present subject disclosure.

FIG. 5 shows a method for handling identification requests, according to an example embodiment of the present subject disclosure.

FIG. 6 shows a method for identifying parts, according to an example embodiment of the present subject disclosure.

FIG. 7 shows a method for determining a supplier part number, according to an example embodiment of the present subject disclosure.

FIG. 8 shows a method for narrowing results to a single part number, according to an example embodiment of the present subject disclosure.

### DETAILED DESCRIPTION OF THE SUBJECT DISCLOSURE

The present subject disclosure solves the problems identified above by using known characteristics of a part to identify that part's equivalent from a supplier with a proprietary part catalog which contains characteristics defined using different structure, standards and nomenclature. In an example embodiment of the present subject disclosure, an estimate including at least one part characteristic is received. The system tries to identify the correct part number or equivalent to a given part, but the supplier may have a different part numbering system than used by the individuals performing the search. However, the supplier has his or her own part-catalog and/or an inventory that associates part characteristics and vehicle identifiers with each part. The system then utilizes at least one part characteristic and/or a vehicle identifier and uses them to search the proprietary supplier catalog to retrieve a part record with substantially similar part characteristics. If no records are found, or if more than one record is found, then additional information is either applied, or requested from the identifying system in order to further qualify the search results. Examples of such information are: point(s) of impact, detailed part descriptions, side, color, size, etc., to find the single record in the supplier's database that best matches the characteristics of the part being identified.

Example embodiments of the present subject disclosure systematically identify the correct supplier part number with up-to-date data from various database aggregators, which retrieve data from various part suppliers and utilize ETL (Extraction, Transformation and Loading) services to keep their database up-to-date. This parts data can alternatively be obtained from other data sources that may be available such as a web-service that aggregates automotive parts data directly from suppliers' catalogs and/or Inventory Management Systems.

“Estimate”, as used herein and throughout this disclosure, refers to any physical or electronic submission that includes at least an automotive part characteristic and a vehicle identifier. An estimate may include more information, such as point(s) of impact, etc., and may include a plurality of part characteristics and vehicle identifiers. An estimate may include an originating part number, which can assist in identifying the correct part, though it is not required by the subject disclosure to identify a supplier part number.

“Part characteristic”, as used herein and throughout this disclosure, refers to any words, abbreviations, codes, etc., that describe a part. Part characteristics are included in estimates used for part identification. A part characteristic may not appear in a single location, such as a “description” field describing the originating part, but may appear in more locations, such as within a “header”, a free-text field, or any other fields related to the part. Part characteristics can appear in estimates, databases, catalogs, inventories, repair orders, part shopping-lists, etc. Part characteristics can also be in a structured data format, or unstructured and free-form data. Vehicle Identifiers may be considered part characteristics when associated with a part.

“Vehicle identifier”, as used herein and throughout this disclosure, refers to any words, numbers, codes, etc., that identify a vehicle uniquely or generally. Examples of vehicle identifiers include make, model, year, vehicle identification number (VIN), compacted VIN, color, engine specification, manufacturer option, dealer option, etc. A part may universally be used in any vehicle, and therefore have no vehicle identifiers, but this is rare. Also, Vehicle Identifiers may serve as part characteristics when associated with a part.

A “Compact VIN” number may consist of the first 8 characters of a VIN+the 10th and the 11th character. This compacted VIN becomes a useful lookup for matching supplier part numbers from their respective catalogs, inventories and/or other databases.

“Supplier”, as used herein and throughout this disclosure, refers to any store, vendor, seller, retailer, etc., of any type of part. Examples of a supplier include a salvage yard, an aftermarket supplier, an e-commerce website, an automotive parts store, a dealership, etc. Information for each part available in a part catalog of a supplier may be listed in a database, catalog, etc., each of which may be available in physical or computer-readable form.

“Part catalog”, as used herein and throughout this disclosure, refers to any supplier specific database containing all available parts as well as part characteristics, and any vehicle identifiers. Part catalogs are often proprietary and have different structures, standards and nomenclature.

Indeed, there are many example embodiments of the subject disclosure. For simplicity, the following example embodiments present, for the most part, a minimal number of structure and components necessary to achieve the functions of the subject disclosure. In many of the following example embodiments, one device, network, server, memory, logic, etc. is shown where a plurality may be used to achieve the same function. Those having skill in the art will recognize these pluralities, which are within the scope of the present subject disclosure.

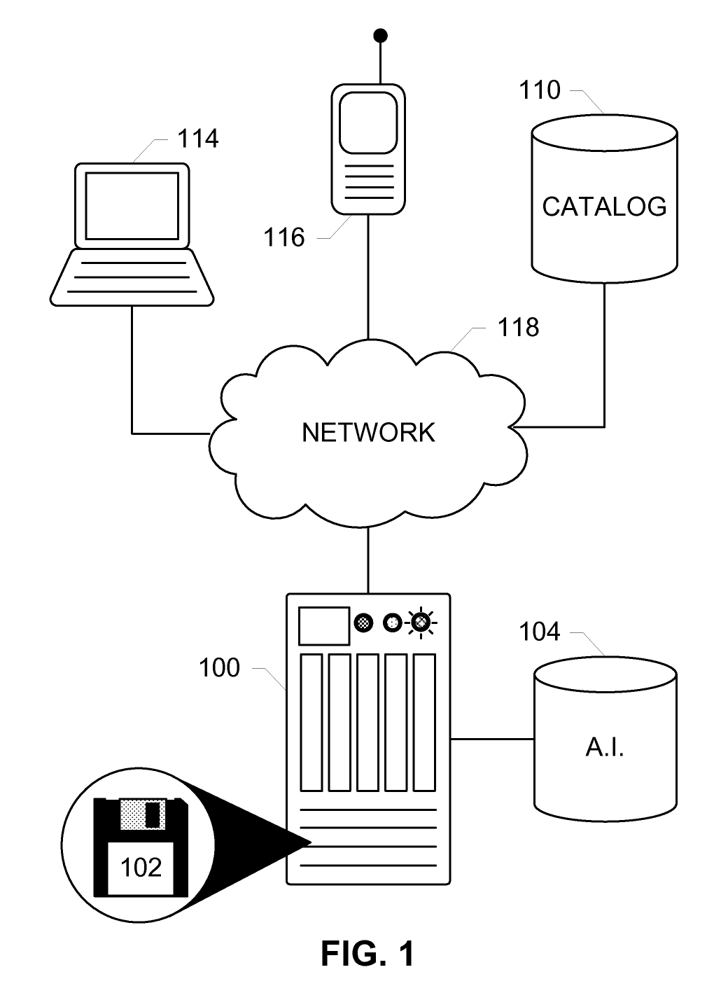

FIG. 1 shows a system for identifying automotive parts, according to an example embodiment of the present subject disclosure. In this example embodiment, the system includes an identification server 100 including an identification logic 102 and an artificial intelligence database 104. The system further includes a part catalog database 110, a client computer 114, and a client mobile device 116, with several of these elements maintaining communication across a network 118. Identification server 100 includes a memory to store identification logic 102 and a processor to execute identification logic upon receiving a part request. Identification server 100 is in communication with artificial intelligence database 104 either directly or through network 118. Identification server 100 is also in communication with part catalog database 110 either directly or through network 118. Client computer 114 and client mobile device 116 are in communication with identification server 100 either directly or through network 118.

Identification logic 102 is a form of logic that, when executed by a processor, performs operations for identifying a part, which will be described in greater detail hereinafter. Logic refers to any information, code, instruction, or data that may be executed to direct the operation of a system. Logic may be stored as computer-executable code or instructions on a non-transitory computer-readable medium, which when executed by a processor carries out instructions on a computer system. Examples of computer-executable logic include, but are not limited to, software, applications, programs, operating systems, applets and sub-applications, coded functions, etc. Logic may also be composed of digital and/or analog hardware circuits, for example any digital IQ, analog IQ, etc., on a complementary metal-oxide-semiconductor (CMOS), silicon germanium (SiGe), silicon-on-insulator (SOI), etc., and other hardware circuits comprising logical AND, OR, XOR, NAND, NOR, and other logical operations. Logic may be formed from combinations of software and hardware.

Examples of computer-readable mediums that may comprise or store logic include, but are not limited to, RAM (random access memory), flash memory, ROM (read-only memory), EPROM (erasable programmable read-only memory), EEPROM (electrically erasable programmable read-only memory), hard drives, disks, diskettes, compact discs (CD), digital versatile discs (DVD), tapes, etc. Examples of processors are computer processors (processing units), microprocessors, digital signal processors, controllers and microcontrollers, etc.

Artificial Intelligence database 104 is a database including at least a record for each part that has been previously identified by identification logic 102. Each record includes the part numbers that were successfully identified from previous identification requests, and any other useful information for enabling a subsequent search for a part. For example, when identifying logic 102 matches an OEM part number with a supplier part number, the supplier part number and the OEM part number are added to the applicable record in artificial intelligence database 104. Any part characteristic, VIN, compacted VIN, or additional information that may be useful in the identification process is also added to the artificial intelligence database under the applicable record. Thus, if a new identification request is received for a part number identified in a previous request, then the part characteristics and vehicle identifiers that were useful in the previous identifications may be easily re-applied for the new identification request.

Client computer 114 and client mobile device 116 are both communication devices capable of submitting an identification request to identification server 100. Communication devices communicate with each other and with other elements via network 118. Network 118 may comprise wireless and wired networks including, but not limited to, broadband wide-area networks such as WiMAX, Long Term Evolution (LTE), etc., cellular networks such as Universal Mobile Telecommunications Systems (UMTS), etc., local-area networks (LAN) such as Ethernet, Wi-Fi, etc., and personal area networks such as near-field communication (NFC), BLUETOOTH(™), ZIGBEE, etc. Communication across network 118 may be packet-based, and may include radio and frequency/amplitude modulations to enable communication between wireless communication devices using appropriate converters and other elements. A plurality of elements may host logic for performing tasks on network 118. This logic may be programmed on a server, or a complex of servers. A particular logic unit is not limited to a single logical location on network 118.

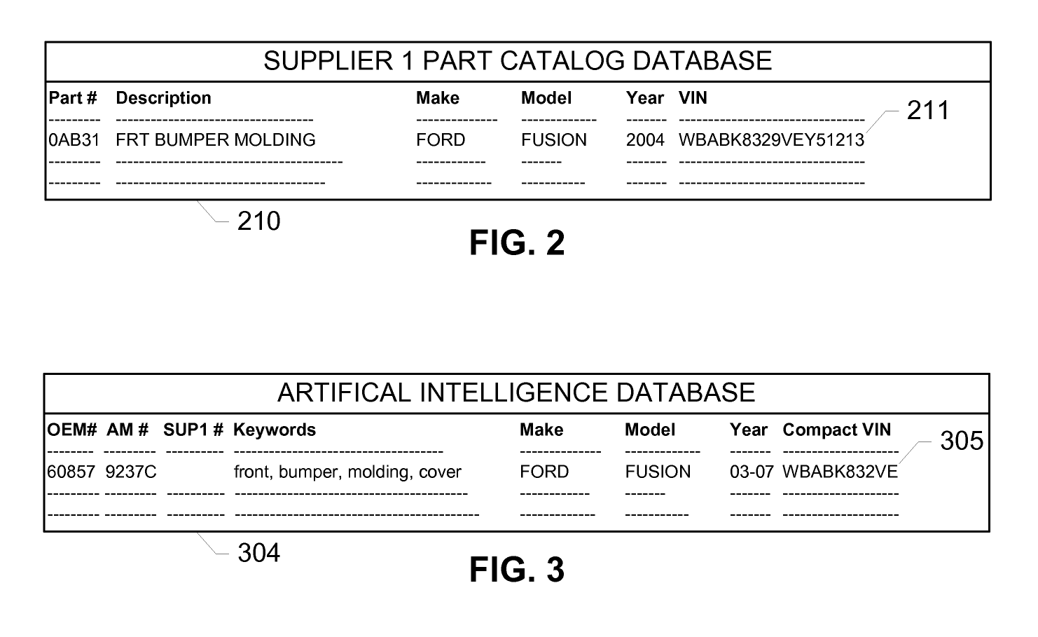

FIG. 2 shows a part catalog database 210, according to an example embodiment of the present subject disclosure. Part catalog database 210 is a database of a supplier that associates each part in their catalog with a unique number for that part. Each part number is further associated with part characteristics. The part characteristics may include keywords to describe the part. The vehicle identifiers may include the make, model, year, and other characteristics of the vehicle associated with the part, or may have more detailed information including a VIN, a compacted VIN, an engine type, etc. A record 211 includes a supplier part number: “OAB31”, part characteristics: “FRT BUMPER MOLDING”, and vehicle characteristics: “FORD FUSION 2004 WBABK8329VEY51213”. Additional information may be depicted in other databases, and will become evident to those having ordinary skill in the art upon reading this disclosure.

FIG. 3 shows an artificial intelligence database, according to an example embodiment of the present subject disclosure. Artificial intelligence database 304 is a database including at least a record for each part that has been previously identified by, for instance, an identification server as described herein. Each record, such as record 305, includes the part numbers that were successfully identified from previous identification requests, and any additional information that may have been useful in identifying a part number matching the previous request. For example, when an OEM part number is matched with a supplier part number, the supplier part number and the OEM part number are added to the applicable record in artificial intelligence database 304. Record 305 includes a previously determined match between OEM part number “60857” and aftermarket part number “9237C”. Any part characteristic, VIN, compacted VIN, or any additional information that may be useful in the matching process is also added to the database under the applicable record. For instance, record 305 includes keywords “front, bumper, molding, cover” and vehicle identifiers “FORD FUSION 03-07 WBABK832VE”. Thus, if a new identification request is received for a part number that may have been included in a previous identification request, then the part characteristics and vehicle identifiers that were useful in the previous identification may be easily re-applied for the new identification.

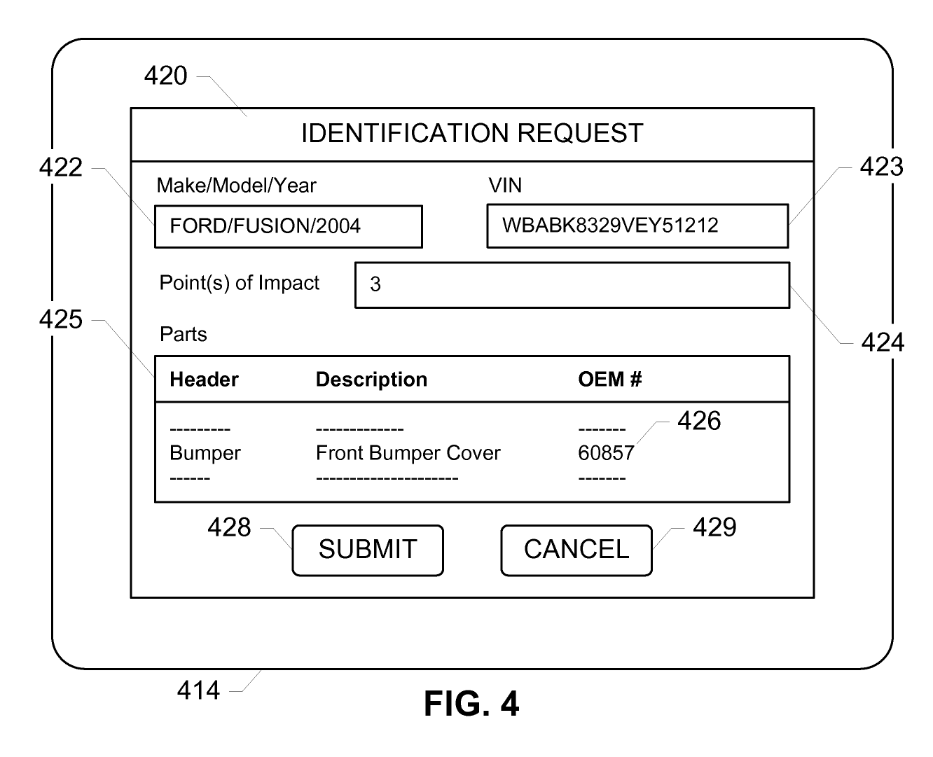

FIG. 4 shows an identification request 420, according to an example embodiment of the present subject disclosure. Identification request 420 includes vehicle identifiers such as a make/model/year field 422 and a VIN field 423. A point-of-impact field 424, and a parts field 425 including line item 426 may be among the additional information in identification request 420. Further, identification request 420 may be provided on an interface generated by a logic on client computer 414, with the interface further providing a submission button 428, and a cancellation button 429. Vehicle identifiers are entered into make/model/year field 422 and VIN field 423 when the associated vehicle identifiers are available. If the vehicle has exterior damage, then one or more points of impact may be entered into point-of-impact field 424. Information for at least one part, such as the part in line item 426, is entered into parts field 425. This information includes part characteristics, and may include an originating part number. The part characteristics may be distributed among a header, a description, a Make/Model/Year, a VIN, a free-text field, etc. Submission button 428 is activated when all desired information has been entered into input fields 422-425. When submission button 428 is activated, identification request 420 is submitted to an identification server by a logic on client computer 414. Cancellation button 429 is activated to clear input fields 422-425 and return to a previous screen of client computer 414, or a new identification request record form.

Identification request 420 may be submitted to the identification server in the form of an email, an XML file, etc. There are many other ways to send the request to the identification server as well, including proprietary formats. Even physical forms can be scanned and submitted to the identification server, where these forms may be scanned, and parsed for information using optical character recognition (OCR), etc.

The logical operations described above and herein may be performed by any combination of a variety of software applications such as database applications from ORACLE, SYBASE, MICROSOFT SQL SERVER DATABASE, etc., capable of producing XML data (or other generic data) for consumption by a listener object, over the Internet. These databases typically contain insurance estimates including all of their pertinent fields such as vehicle information, line items, and their headers, descriptions, default part numbers, repair facility information, total value of the estimate, and name and contact information of all the parties involved in the repair process.

These estimates and all of their related information are then electronically transmitted to computer servers, accessible by the identification server. They are generally received in the industry format known as Estimating Management System (EMS), but can be in any computer-readable format. The identification server receives these estimates and sends an acknowledgment back to the sender as to the successful receipt. Once a copy of an electronic estimate is received by the identification server, the identification server begins processing of the estimate.

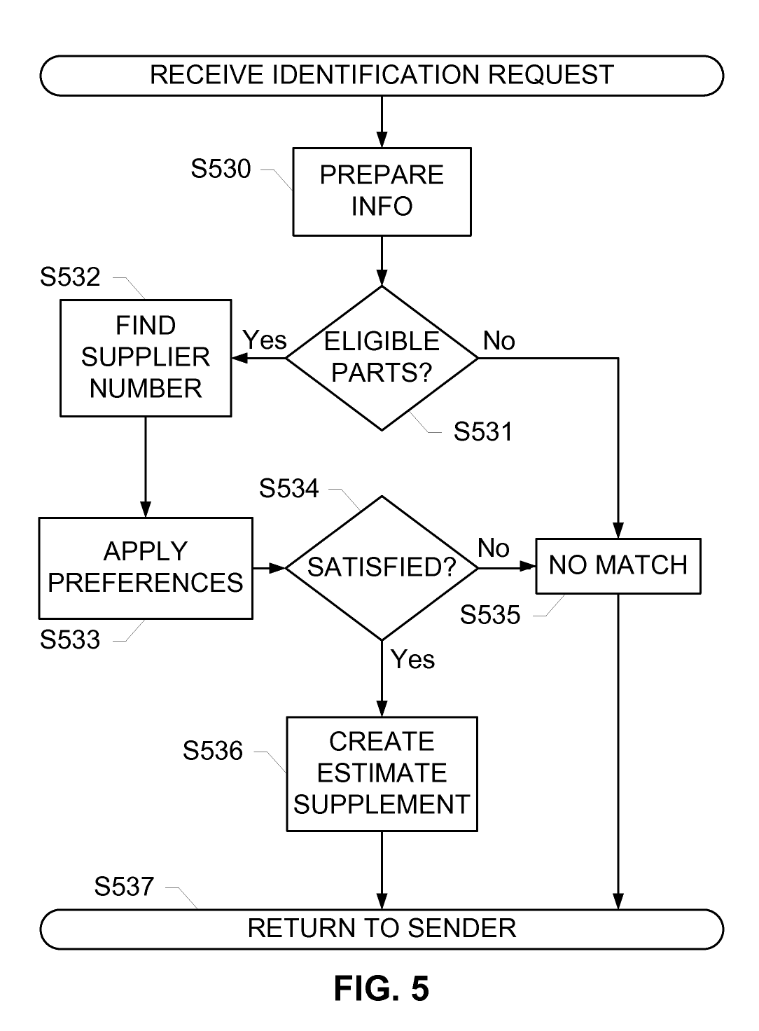

FIG. 5 shows a method of handling identification requests, according to an example embodiment of the present subject disclosure. In this example embodiment, the method begins when an estimate, or identification request, is received at the identification server. Initially, the information in the estimate is prepared to ensure that the request is legitimate and able to be processed by the system (S530). Preparing the information may include removing non-part information, removing non printable characters, converting abbreviations, normalizing, converting free-text form to standard form, etc. For instance, abbreviations may be compacted or expanded based upon information stored in an artificial intelligence database, or any other database of commonly-used abbreviations. Once normalized, the estimate is searched for eligible parts that can be matched with a supplier (S531).

If there are eligible parts that can be matched, then at least one supplier's part catalog is searched for a matching supplier part number (S532) for each eligible part in the identification request. Once the supplier part numbers are found, then additional preferences are applied (S533). These preferences, further described in detail below, may be set by the client to avoid receiving part numbers from undesired suppliers, etc. If the preferences are not satisfied, or if there were no eligible parts to begin with, then the system informs the requester that there were no matches found (S535). If the preferences are satisfied, then a supplemental repair estimate is created in the form and data structure suitable for importing back into the original estimating system (S536). The supplemental repair estimate, or supplement, includes any and all supplier part numbers corresponding to line items in an estimate that satisfy the preferences. A supplemental repair estimate may be in a form suitable for importing into an originating part's estimating system. The supplemental repair estimate may be in a form that interfaces with at least one of a repair estimating computer system and a shop management computer system

Finally, the sender is informed of unavailability of parts or the estimate supplement is returned to the sender, or client (S537).

The preferences may be set by the insurance company financing the repair, the repair facility carrying out the repair, and/or any other requester. The preferences may include a distance of the supplier from the repair facility or from the client, the extent of warranty that the part supplier provides, quality of the part, price, certification, reliability of the part supplier as determined by a variety of sources such as online reviews, etc. This operation further filters out the search results according to the insurance company's and/or repair facility's preferences in terms of warranty, freshness of the data, part certification, percentage of savings produced on the parts, rating of the supplier, etc. Preferences for suppliers of aftermarket parts may be different than preferences for suppliers of used parts. For example, a minimum amount of savings may be larger for a used part supplier than for an aftermarket part supplier.

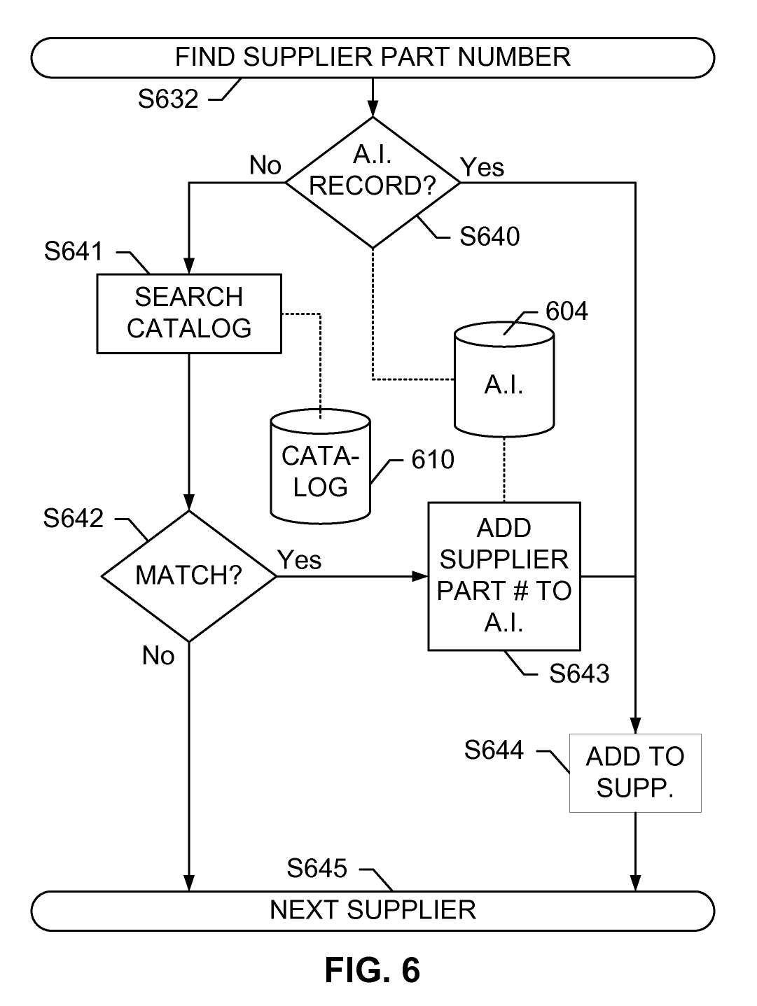

FIG. 6 shows a method for identifying parts, according to an example embodiment of the present subject disclosure. The method begins with an initiation of an operation for finding a supplier part number (S632). Finding supplier part number (S632) may be performed for multiple suppliers or a specific supplier, depending on the request, server capabilities, etc., and thus, the method of FIG. 6 may be performed more than once for each part in an identification request. For instance, a request submitted by a sender such as request 420 in FIG. 4 may not be specific to a supplier. Therefore, every supplier satisfying applicable preferences may be searched for supplier part numbers. Alternatively, the identification request may be restrained or conditioned to one or more specified suppliers, in which case only the specified part catalog databases are searched. In this example embodiment, the method begins by checking an artificial intelligence database 604 for a record including the part number included in a request (S640). For example, in processing identification request 420 in FIG. 4, artificial intelligence database 304 may be searched for “60857”. In this example, artificial intelligence database 304 yields a supplier part number from an aftermarket supplier.

However, there may be other suppliers matching any applicable preferences without associated supplier part numbers in artificial intelligence database 604. For these suppliers, a part catalog database 610 is searched for part characteristics, vehicle identifiers, and other data that are substantially similar to the part characteristics, vehicle identifiers, and other data included in the identification request (S641). The part characteristics are assigned weights and searched in order from the most probabilistic, e.g. characteristics that have the highest weight, to the least probabilistic or characteristics that have the lowest weight. For example, with reference to FIG. 2, supplier 1 part catalog database 210 may be searched for a record including part characteristics and vehicle identifiers substantially similar to “bumper: front bumper cover” and “FORD/FUSION/2004: WBABK8329VEY51212”. If this search yields a match from part catalog database 610 (S642), then the supplier part number of the matching record in part catalog database 610 is added to applicable record in artificial intelligence database 604 (S643). For example, if a search of supplier 1 part catalog 210 yields record 211 as a match, then “OAB31” is added to record 305 artificial intelligence database 304 under “SUP1 #”. An originating part number may not be present in the identification request. A hash may be created using all of the characteristics and added to the applicable record instead of or in addition to the originating part number matching the supplier part number. For example, a hash for record 305 may be “FRTBMPCVFOFU0307” where each abbreviation is a representative of the characteristics necessary to accurately identify a given part.

Once the supplier part number is added to the artificial intelligence database 604, or in case the supplier part number was already present in artificial intelligence database 604, the supplier part number is designated as equivalent of the originating part. If this search does not yield a supplier part number from part catalog database 610 (S642), or once the identified supplier part number has been added to an estimate supplement, then the process is repeated with the next supplier (S645).

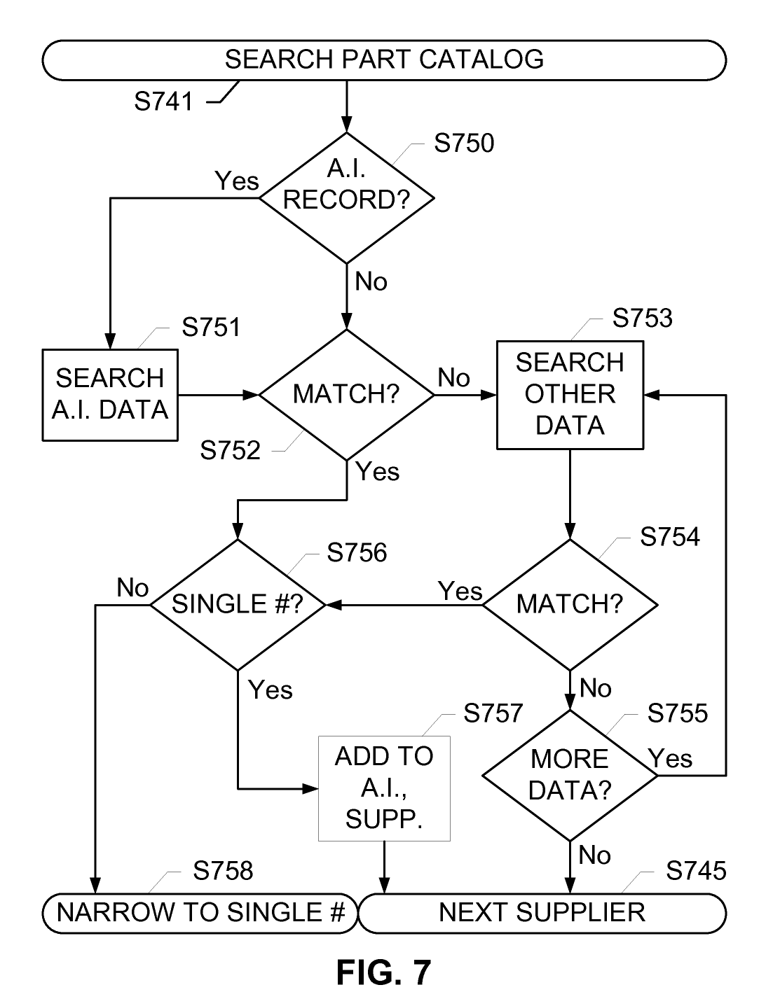

FIG. 7 shows a method for determining a supplier part number, according to an example embodiment of the present subject disclosure. In this example embodiment, the method begins after a determination that a supplier part number is not already in the artificial intelligence database, and that the supplier part catalog must be searched (S741). For instance, the supplier part catalog may be search by applying information extracted from the identification request to the supplier's database of parts to find matching part numbers. At a minimum, the part characteristics and vehicle identifiers in the identification request are used in the search. However, if there is an applicable record (S750), then any extra data from the record, such as keywords, part type, etc., are also applied (S751). For example, with reference to FIGS. 3 and 4, carrying out identification request 420 may include applying the keyword “molding” to the search, since although it does not appear in identification request 420, record 305 of artificial intelligence database 304 is associated with the part in identification request 420.

Next, it is determined whether there is at least one match from this search (S752). If there is not at least one matching part number in the supplier part catalog, then additional information is used to search the supplier part catalog (S753). The additional information may be acquired from any other information source, database, parts catalog, etc. For example, more keywords from a matching record of a part-type database, another supplier part catalog database, a thesaurus, etc., that do not appear in the identification request can be used in the search. For another example, used parts knowledge may be extrapolated from a database of actual used auto parts using a vehicle identification number (VIN) in the repair estimate. If the search using the additional information does not result in at least one matching part number (S754), then it must be determined whether even additional information is available (S755). If additional information is available, then another search is performed using the available data (S753). This process repeats until either all available information has been exhausted in a search, or at least one matching record is found in the part catalog database.

If no matching record is found, and if all available data has been used in a search, then the process ends or moves to the next supplier (S745). If at least one matching record is found, then it is determined if there is more than one matching record (S756). If there is more than one matching record, then the results must be narrowed to a single supplier part number (S758). This narrowing process may include applying preferences to the multiple results, by eliminating results based on additional information within the results, by providing a prompt to a human operator to choose between the plurality part numbers with different characteristics that have not been resolved based on the current part identification. For instance, a result for a part number may include specific words in its associated description that may render the part unmatchable, even if the result was properly retrieved, such as a specific subset of a part, or a limited edition part that is specific only to a subset of vehicle identifiers. If there is only a single record, then the supplier part number of that record, along with any other part characteristic, is added to the artificial intelligence database (S757), and the process repeats for the next supplier (S745).

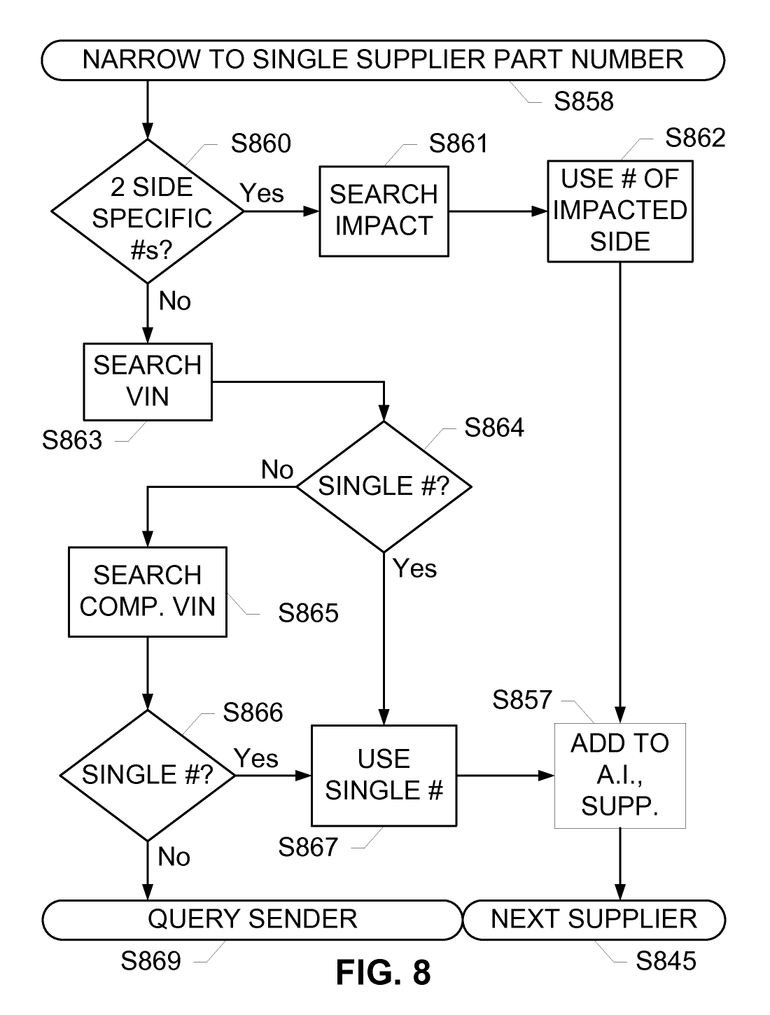

FIG. 8 shows a method for narrowing results to a single part number, according to an example embodiment of the present subject disclosure. In this example embodiment, the method begins when more than one matching record has been yielded from a search of a part catalog database (S858). If there are exactly two matching records, then the records are compared to determine if they correspond to different sides of a vehicle (S860). If the two records do correspond to different sides, then a point of impact extracted from the identification request can be used to distinguish the records (S861). The supplier part number of the record that matches the point of impact from the identification request is then determined to be the single best result (S862). For example, in carrying out identification request 420 in FIG. 4, point of impact “3” may be used to determine that the best record matches the side corresponding to the point of impact “3”. However, if there are not two matching records, or if they do not correspond to different sides, then the part catalog database may be searched for a part number having the closest matching VIN(s) (S863). This operation may only apply when searching used part inventories or part catalogs that associated whole VINs with each part.

For example, supplier 1 part catalog database 210 may be searched for the closest records to “WBABK8329VEY51212”, which yields record 211, since “WBABK8329VEY51213” is substantially similar to the VIN in identification request 420. If the closest matching VIN(s) do not yield one result (S864), then the part catalog database may be searched for the compacted VIN (S865). For example, supplier 1 part catalog database 210 may be searched for the records matching the compacted VIN “WBABK832VE”, which yields record 211, since “WBABK8329VEY51213” breaks down into the same compacted VIN as the VIN in identification request 420. If there is more than one record associated with the compacted VIN (S866), then a query is sent to the sender of the identification request including all of the matching records (S869). The differences among the matching records may be highlighted in the query. If the results are narrowed to a single record, then the supplier part number of the remaining record is then added to the artificial intelligence database and to an estimate supplement (S857) before the process is repeated for the next supplier (S845).

For another example, a 1995 Pontiac Firebird has two types of Tail

Lamps: one with a Plain Lens, and one with a Checkered Lens. The estimate may have included the words “CLEAR LENS” in the line item for the Tail Lamp that needed to be replaced for a given vehicle. The identification logic may determine that the words “CLEAR and LENS” are referring to the keywords “PLAIN LENS” in a supplier's description field. This is done by properly identifying that the words CLEAR and PLAIN mean the same thing, which may be determined by referencing a thesaurus, and by mapping the word LENS to that of the word LENS in the supplier's description field. This may enable the identification logic to specify and search for the correct Tail Lamp, namely the one described by the supplier to have “PLAIN LENS” as opposed to the one described to have a “CHECKERED LENS”.

In case of identification of used or LKQ parts when there are more than two possible supplier part numbers, the identification logic uses a VIN-to-part-number lookup procedure. This procedure attempts to ascertain a correct part number from a supplier by analyzing the supplier's part catalog for VIN numbers and corresponding part numbers. This relies on the VIN numbers and part characteristics that were entered by thousands of automobile recyclers in their Inventory Management Systems along with the supplier part numbers corresponding to those parts that were dismantled from the vehicles and cataloged using those vehicle's VIN numbers.

When running a query for all the records that match a Compacted VIN number composed from the VIN number of the vehicle for which the current repair estimate was received, the identification logic may check to see if the number of matching records is greater than a minimum amount. This minimum amount may be set by the operators of the identification server. This amount determines the accuracy of the selection process. The higher the amount, the more matches against no matches have to be made for the match to be considered accurate. For example, an amount of 3 means that the identification logic relies on the knowledge of the 3 separate individuals, who dismantled, and cataloged 3 separate parts (using their same part number) for 3 separate vehicles and entered the same exact Compact VIN number for each separate part. This provides a sufficient degree of certainty for the identification logic to select the correct supplier part number for a part that has the same Compacted VIN number in the line item of an estimate.

Moreover, the artificial intelligence database may be able to be updated by part suppliers themselves. In addition to the automated building of the database as performed by the methods described herein, an interface may be provided to suppliers to update records corresponding to the part numbers in their own respective catalogs. This feature may additionally be extended to enabling subscribers to opt in or opt out of the artificial intelligence database, with subscribers that opt in being able to customize their part information in the artificial intelligence database, as well as being able to receive additional business for their products, provide rewards to customers that find their parts from the artificial intelligence database, and offer specials and discounts to specific requestors based on a frequency of requests, number of parts required, etc. This feature may further be enabled by providing suppliers with a list of parts in the identification request, and enabling suppliers to dynamically price their parts based on the list of parts requested.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A method for effectively identifying a part based on a plurality of part characteristics that are defined in a non-obvious form with respect to a proprietary supplier catalog where those characteristics are defined using different structure, standard, and nomenclature, the method comprising:
identifying a supplier part number in the proprietary supplier catalog using the plurality of part characteristics.

2. The method in claim 1, further comprising associating at least one of an originating part number and a hash number with the supplier part number in an artificial intelligence database, where the originating part number is sent with the plurality of part characteristics, and the hash number is generated from the plurality of part characteristics.

3. The method in claim 2, further comprising subsequently referencing the supplier part number from at least one of the originating part number and the hash number using the artificial intelligence database.

4. The method in claim 1, further comprising preparing the plurality of characteristics by converting at least one free-form characteristic to a standard form characteristic using regular expressions or other pattern recognition methodologies.

5. The method in claim 1, wherein the identifying includes using a plurality of part characteristics in order from most probabilistic to least probabilistic.

6. The method of claim 1, wherein the identifying includes extrapolating used parts knowledge from a database of actual used auto parts using a vehicle identification number (VIN) in the repair estimate.

7. The method in claim 6, wherein the determining includes referencing a compacted vehicle identification number (VIN) including the first 8 characters, the tenth character, and the eleventh character of a VIN further included in the estimate.

8. The method in claim 1, wherein the matching further comprises narrowing the supplier part number from a plurality of possible supplier part numbers returned from the proprietary supplier catalog.

9. The method in claim 1, further comprising returning a supplemental repair estimate in a form suitable for importing into an originating part's estimating system, the supplemental repair estimate including at least the supplier part number.

10. The method in claim 9, wherein the supplemental repair estimate includes a plurality of supplier part numbers corresponding to a plurality of line items.

11. The method of claim 10, wherein the supplemental repair estimate is in a form that interfaces with at least one of a repair estimating computer system and a shop management computer system.

12. A system for effectively identifying a part based on a plurality of part characteristics that are defined in a non-obvious form with respect to a proprietary supplier catalog where those characteristics are defined using different structure, standard, and nomenclature, the system comprising:
a server including a processor; and
a computer-readable medium in communication with the server, the computer-readable medium having a plurality of instructions stored thereon which, when executed by the processor, cause the processor to perform operations including
identifying a supplier part number in the proprietary supplier catalog using the plurality of part characteristics.

13. The system in claim 12, further comprising an artificial intelligence database in communication with the server, the artificial intelligence database storing an association of at least one of an originating part number and a hash number with the supplier part number in an artificial intelligence database, the originating part number sent with the plurality of part characteristics, and the hash number generated using the plurality of part characteristic.

14. The system in claim 12, further comprising a preferences database including at least one condition which must be satisfied before returning a supplement, the supplement including the supplier part number.

15. The system in claim 12, wherein the proprietary supplier catalog is a proprietary supplier catalog database in communication with the server.

16. The system in claim 12, further comprising a reference database in communication with the server.

17. A non-transitory computer-readable medium having a plurality of instructions stored thereon which, when executed by a processor, cause the processor to perform a method for effectively identifying a part based on a plurality of part characteristics that are defined in a non-obvious form with respect to a proprietary supplier catalog where those characteristics are defined using different structure, standard, and nomenclature, the method comprising:
identifying a supplier part number in the proprietary supplier catalog using the plurality of part characteristics.

18. The non-transitory computer-readable medium in claim 17, further comprising associating at least one of an originating part number and a hash number with the supplier part number in an artificial intelligence database, the originating part number sent with the plurality of part characteristics, and the hash number generated using the plurality of part characteristics.
